(19) United States
(12) Patent Application Publication
(10) Pub. No.: US 2007/0122672 A1
(43) Pub. Date: May 31, 2007

(54) Fuel cell

(76) Inventors: Ho-Jin Kweon, Suwon-si (KR); Sung-Jin Kim, Suwon-si (KR)

Correspondence Address: Robert E. Bushnell, Suite 300, 1522 K Street, N.W., Washington, DC, 20005, US

(21) Appl. No.: 11/605,968

(22) Filed: Nov. 30, 2006

(30) Foreign Application Priority Data
Nov. 30, 2005 (KR) 10-2005-0115536

(51) Int. Cl. H01M 8/10; H01M 8/00

(52) U.S. Cl. 429/30; 429/13

(57) ABSTRACT

A fuel cell including a absorbing member is provided to improve performance and reliability of the fuel cell. The fuel cell includes an electricity generation unit and a medium member. The electricity generation unit includes a fuel supply unit, and a membrane electrode assembly (MEA), absorbing member, and air supply unit. A fuel is supplied through the medium member, and air is supplied through the air supply unit. During oxidation/reduction reaction between a fuel and air, condensed moisture or water is produced inside fuel cell, and the condensed moisture can block path of air flow into the fuel cell. In order to solve this problem, absorbing member is disposed between the membrane electrode assembly and the air supply unit. The absorbing member effectively absorbs moisture and blocking of air flow path by the moisture is prevented.

### CLAIM OF PRIORITY

This application makes reference to, incorporates the same herein, and claims all benefits accruing under 35 U.S.C.§119 from an application for FUEL CELL earlier filed in the Korean Intellectual Property Office on 30 Nov. 2005 and there duly assigned Serial No. 10-2005-0115536.

### BACKGROUND OF THE INVENTION

1. Field of the Invention

The present invention relates to a fuel cell that can generate electric energy using a reaction between fuel and oxygen.

2. Description of the Related Art

A fuel cell is an electricity generating system for directly converting energy, which is generated by chemical reaction between hydrogen contained in fuel and externally supplied oxygen, into electric energy. The oxygen supplied to unit cells of the fuel cell can be obtained from atmospheric air that flows by natural diffusion or convection.

When the fuel cell operates, vaporized moisture generated by a reduction reaction with the air is condensed when the moisture contacts atmospheric air. The condensed moisture or water may block an air flow path provided in the fuel cell. When the atmospheric air is not effectively supplied to the unit cells due to the condensed water that blocks the air flow path, the performance and reliability of the fuel cell are deteriorated. Therefore, it is required that the condensed water should be removed to improve the performance and reliability of a fuel cell.

### SUMMARY OF THE INVENTION

The present invention provides a fuel cell that is designed to absorb moisture generated by an electrochemical reaction between fuel and oxygen. In an exemplary embodiment of the present invention, a fuel cell includes an electricity generation unit including an air supply unit, a fuel supply unit and an membrane electrode assembly (MEA) disposed between the air supply unit and the fuel supply unit, and an absorbing member that is installed on the air supply unit to absorb moisture. The absorbing member can be disposed between the air supply unit and the MEA. The air supply unit can be exposed to the atmospheric air. The absorbing member can closely contact an exposed of the air supply unit to the atmospheric air.

The absorbing member can be formed of a porous medium material. The air supply unit can be provided with a plurality of air holes through which the atmospheric air is supplied to the MEA. The absorbing member can be provided with a plurality of holes communicating with the airholes.

In another exemplary embodiment of the present invention, a fuel cell includes a medium member having at least one unit region and a manifold along which fuel flows, a fuel supply unit having a first passage along which the fuel flows and mounted on the unit region, MEA closely contacting the fuel supply unit, air supply unit having a second passage along which air flows and closely contacting the MEA, and an absorbing member that is installed on the air supply unit to absorb moisture.

The absorbing member can include a porous layer formed of a porous medium material and a moisture absorption layer formed on at least one surface of the porous layer. The moisture absorption layer can be formed of zeolite or phosphoric oxide (P₂O₅). The absorbing member can be disposed between the air supply unit and the MEA such that the moisture absorption layer closely contacts the MEA.

The absorbing member can include a porous layer formed of a porous medium material and a moisture absorption layer formed on a surface of the porous layer. At this point, the moisture absorption layer can closely contact an exposed surface of the air supply unit. The air supply unit can be formed of a first current collection plate and the fuel supply units can be formed of a second current collection plate. The first and second current collection plates can differ in polarity.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a fuel cell constructed as an exemplary embodiment of the present invention;

FIG. 2 is a front view of a medium member shown in FIG. 1;

FIG. 3 is an exploded perspective view of a medium member shown in FIG. 2;

FIG. 4 is a front view of a fuel supply unit shown in FIG. 1;

FIG. 5 is a front view of an air supply unit shown in FIG. 1;

FIG. 6 is a sectional view of an electricity generation unit of a fuel cell constructed as an exemplary embodiment of the present invention;

FIG. 7 is an exploded perspective view of a fuel cell constructed as another exemplary embodiment of the present invention; and

FIG. 8 is a sectional view of an electricity generation unit of a fuel cell constructed as another exemplary embodiment of the present invention.

### DETAILED DESCRIPTION OF THE INVENTION

Hereinafter, exemplary embodiments of the present invention will be described in detail with reference to the attached drawings such that the present invention can be easily put into practice by those skilled in the art. However, the present invention is not limited to the exemplary embodiments, but can be embodied in various forms.

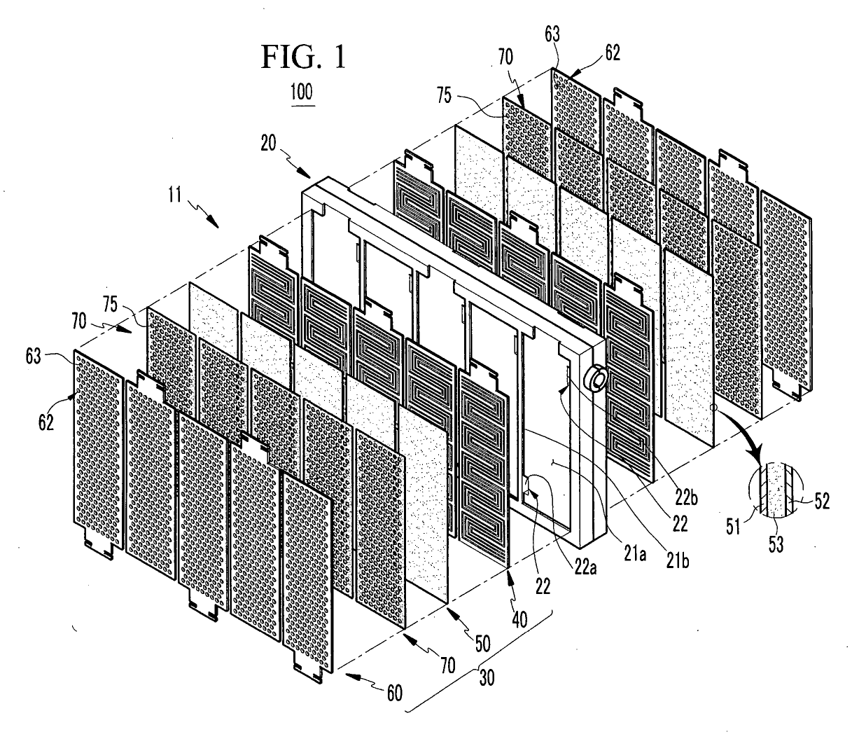

FIG. 1 is an exploded perspective view of a fuel cell constructed as an exemplary embodiment of the present invention. Referring to FIG. 1, fuel cell 100 is configured as an electricity generation system that is connected to an electronic device or integrally mounted in the electronic device to generate electric energy using an electrochemical reaction between fuel and oxygen, and to output the generated electric energy to the electronic device. Fuel cell 100 is directly supplied with an alcohol-based fuel such as methanol or ethanol and atmospheric air to generate the electric energy using an oxidation reaction of hydrogen contained in the fuel and a reduction reaction of the oxygen contained in atmospheric air.

Fuel cell 100 includes fuel cell main body 1I that is supplied with a fuel from a fuel source (not shown) and atmospheric air that flows by natural diffusion or convection, and that generates electric energy by the oxidation/reduction reaction between the fuel and the atmospheric air. Fuel cell main body 11 is formed in a plate type with two opposite surfaces. Fuel cell 100 is configured to be supplied with the atmospheric air through both surfaces of fuel cell main body 11.

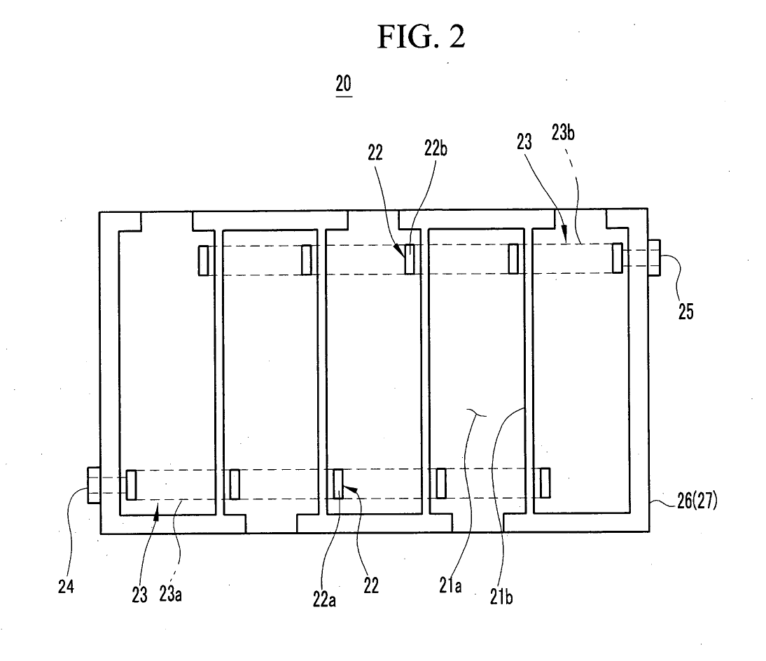

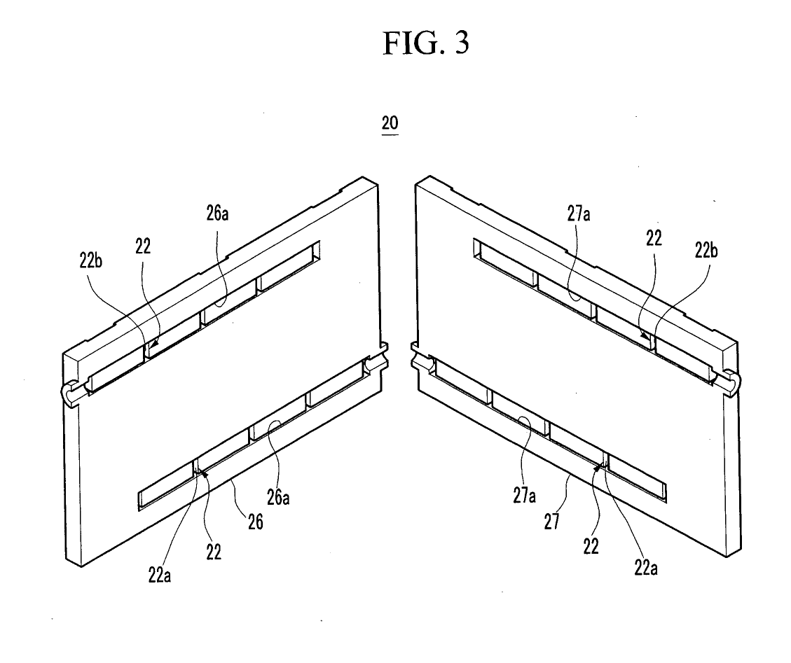

Fuel cell 100 includes medium member 20 and a pair of electricity generation units 30 that are symmetrically disposed to face each other with medium member 20 interposed between the pair of electricity generation units 30. Medium member 20 functions as a separator for separating electricity generation units 30 from each other. Medium member 20 is formed of an insulation material that allows a fuel to flow through both surfaces thereof. Medium member 20 will be described in more detail later with reference to FIGS. 2 and 3.

Electricity generation unit 30 is provided as a fuel cell having a plurality of unit cells, which generates electric energy using the reaction between a fuel and atmospheric air. Electricity generation unit 30 includes fuel supply unit 40 closely contacting a surface of medium member 20, membrane-electrode assembly (MEA) 50 closely contacting fuel supply unit 40, absorbing member 70 contacting MEA 50, and air supply units 60 contacting absorbing member 70.

Medium member 20 is formed in a rectangular shape. Medium member 20 includes a plurality of unit regions 21a, coupling grooves 21b, manifold 22, outlet 22a, and inlet 22b. MEA 50 includes first electrode layer 51, second electrode layer 52, and electrolyte layers 53. Air supply units 60 includes second passage 62 and air holes 63. Absorbing member 70 includes a plurality of holes 75. The function of each element will be described in detail referring to FIGS. 2-6.

As shown in FIG. 2, each surface of medium member 20 is provided with a plurality of unit regions 21a that are disposed on the surface of medium member 20 and are spaced apart from each other. Manifold 22, which allows a fuel to flow with respect to fuel supply unit 40, is formed in each unit region 21a. Fuel passage 23 communicating with manifold 22 is formed in medium member 20.

Unit region 21a is an active area where a unit cell of electricity generation unit 30 is located, and a fuel is supplied to MEA 50 so that the reaction between the fuel and atmospheric air is actually performed in electricity generation unit 30. Unit region 21a is formed extending in a lateral direction (vertical direction as shown in FIG. 2), which is perpendicular to fuel passage 23, and therefore the plurality of unit regions 21a commonly share fuel passage 23. Unit regions 21a are spaced apart from each other in a longitudinal direction (horizontal direction as shown in FIG. 2), which is parallel to fuel passage 23. Each of unit regions 21 has coupling groove 21b to which each of fuel supply units 40 is respectively coupled. Coupling groove 21b also can be defined as a space formed between two unit regions 21a when unit region 21a protrudes outwards. In this case, majority portions of the surface of medium member 20 except coupling groove 21b become protruding portions, and coupling groove 21b is a space formed between the protruding portions.

Fuel passage 23 formed in medium member 20 extends in the longitudinal direction of medium member 20. Fuel passage 23 includes first passage 23a along which a fuel is supplied from a fuel supply device (not shown), and second passage 23b along which a fuel from fuel supply unit 40 flows. At this point, first passage 23a is formed along a lower edge of medium member 20 while second passage 23b is formed along an upper edge of medium member 20. First and second passages 23a and 23b are parallel to each other.

Manifold 22 formed in each unit region 21a of medium member 20 includes outlet 22a communicating with first passage 23a and inlet 22b communicating with second passage 23b. The fuel flowing along first passage 23a is directed to a passage of fuel supply unit 40 through outlet 22a. The fuel passing through fuel supply unit 40 is directed to second passage 23b through inlet 22b. In addition, medium member 20 is provided at a first side portion with fuel injection portion 24 through which a fuel is injected into first passage 23a of fuel passage 23, and at a second side portion with fuel exhaust portion 25 through which the fuel passing through second passage 23b is exhausted. At this point, fuel injection portion 24 can be connected to the fuel supply device (not shown) through, for example, a typical pipe line.

As shown in FIG. 3, medium member 20 includes first and second halves 26 and 27 that face each other and are integrally assembled with each other, thereby forming fuel passage 23 shown in FIG. 2. First half 26 is provided at an inner surface with first grooves 26a corresponding to first and second passages 23a and 23b. Second member 27 is also provided at an inner surface with second grooves 27a corresponding to first and second passages 23a and 23b. The inner surfaces of first and second halves 26 and 27 face each other. Therefore, unit regions 21a are formed outer surfaces (opposite surfaces of the inner surfaces) of first and second halves 26 and 27. When first and second halves 26 and 27 are assembled with each other in a manner that the inner surfaces of first and second halves 26 and 27 face each other, fuel passage 23 is formed in medium member 20.

The following paragraphs will describe electricity generation units 30 symmetrically disposed on both opposite surfaces of medium member 20 as shown in FIG. 1. Electricity generation unit 30 includes fuel supply unit 40, membrane-electrode assembly (MEA) 50, absorbing member 70, and air supply unit 60.

Membrane-electrode assembly (MEA) 50 includes electrolyte membrane 53, first electrode layer 51 formed on a first surface of electrolyte membrane 53, and second electrode layer 52 formed on a second surface of electrolyte membrane 53. First electrode layer 51 decomposes hydrogen contained in a fuel into electrons and hydrogen ions. Electrolyte membrane 53 moves the hydrogen ions to second electrode layer 52. Second electrode layer 52 allows the electrons and hydrogen ions supplied from the first electrode layer 51 to react with oxygen contained in the atmospheric air so as to generate moisture and heat. MEA 50 has the same size as fuel supply unit 40 and air supply unit 60. A typical gasket (not shown) can be provided on an edge of MEA 50.

In the present exemplary embodiment, fuel supply unit 40 closely contacts first electrode layer 51 of MEA 50, and is mounted on unit regions 21a. Fuel supply unit 40 distributes a fuel to first electrode layer 51 of MEA 50. Fuel supply unit 40 also functions as a conductor for moving electrons, which are extracted from hydrogen contained in a fuel, to air supply unit 60 of electricity generation unit 30.

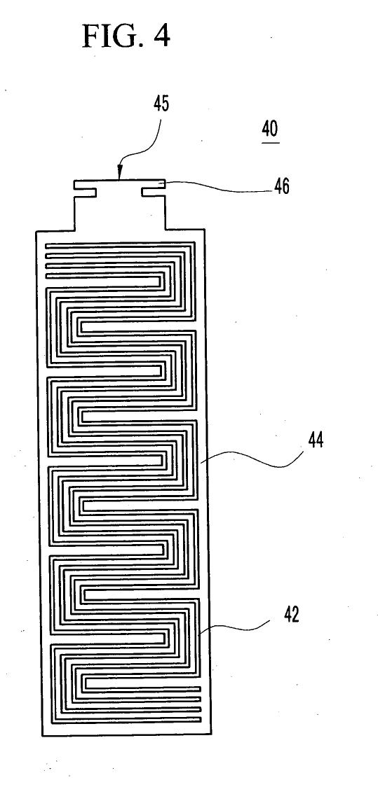

As shown in FIG. 4, fuel supply unit 40 has first passage 42 along which a fuel flows and is mounted in corresponding unit region 21a. Fuel supply unit 40 is formed of a conductive metal plate, and designed in a manner that multiple fuel supply units 40 are fit in the size of MEA 50. Fuel supply unit 40 is designed to be coupled to coupling groove 21b defined in unit region 21a.

Since fuel supply unit 40 functions as a conductor for moving electrons to air supply unit 60 of electricity generation unit 30, fuel supply unit 40 can include current collection plate (or a second current collection plate) 44 having a polarity that is different from that of air supply unit 60.

Fuel supply unit 40 is provided with terminal portion 45 that is electrically connected to air supply unit 60 of electricity generation unit 30 through an electrical connector such as a conductive wire. Terminal portion 45 is integrally formed with fuel supply unit 40. Terminal portion 45 is formed in protrusion 46 extending out of an edge of medium member 20. If there are multiple fuel supply units 40, fuel supply units 40 are arranged in a manner that protrusions of fuel supply units 40 are alternately heading upwards and downwards as shown in FIG. 1.

First passage 42 includes a plurality of flow paths that connect outlet 22a of manifold 22 to inlet 22b of the manifold 22 in order to distribute the fuel injected into first passage 23a of medium member 20 to first electrode layer 51 of the MEA 50.

First passage 42 is made by forming a predetermined pattern on the plate of fuel supply unit 40. For example, first passage 42 can have a plurality of straight lines that are spaced apart from each other, and are formed into a square wave shape (meander shape) as shown in FIG. 4. One end of first passage 42 is connected to outlet 22a of manifold 22, and the other end is connected to inlet 22b of manifold 22.

In the current exemplary embodiment, air supply unit 60 are arranged in close contact with absorbing member 70 which is in close contact with second electrode layer 52 of MEAs 50. Air supply unit 60 functions to distribute air to second electrode layer 52 of MEA 50 by natural diffusion or a process of convection. Air supply unit 60 also functions as a conductor for receiving electrons from fuel supply unit 40.

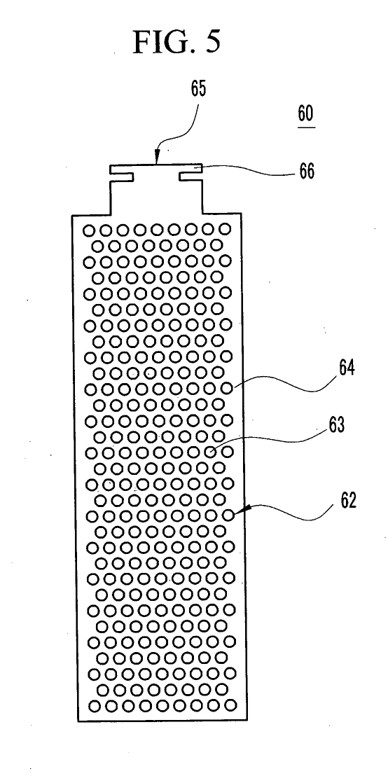

As shown in FIG. 5, air supply unit 60 has second passage 62 along which air is distributed to second electrode layer 52 of MEA 50. Air supply unit 60 is formed of a conductive metal plate. Air supply unit 60 has a size corresponding to the size of fuel supply unit 40. Second passage 62 includes a plurality of air holes 63 formed on a plane of air supply unit 60.

Since air supply unit 60 functions as a conductor for receiving electrons from fuel supply unit 40, air supply unit 60 can include a current collection plate (or a first current collection plate) 64 having a polarity that is different from that of fuel supply unit 40.

Air supply unit 60 is provided with terminal portion 65 that is electrically connected to terminal portion 45 of fuel supply unit 40 of electricity generation unit 30 through an electrical connector such as a conductive wire. Terminal portion 65 is integrally formed with air supply unit 60. That is, the terminal portion 65 is formed by a protrusion 66 extending out of an edge of medium member 20. If there are multiple air supply units 60, air supply units 60 are arranged in a manner that protrusions 66 of air supply units 60 are alternately heading upwards and downwards as shown in FIG. 1.

When above described fuel cell 100 operates, first electrode 51 of MEA 50 decomposes hydrogen contained in a fuel supplied through first passage 42 of fuel supply unit 40 into electrons and hydrogen ions by an oxidation reaction of the fuel. At this point, the hydrogen ions move to second electrode layer 52 through electrolyte layer 53. The electrons cannot pass through electrolyte layer 53 but move to second electrode layer 52 of MEA 50 through the electrical connector that connects protrusion 66 of air supply unit 60 to protrusion 46 of fuel supply unit 40

At the same time, second electrode layer 52 generates vaporized moisture through a reduction reaction between the hydrogen ions supplied through electrolyte layer 53, the electrons supplied through the electrical connector that connects air supply unit 60 to fuel supply unit 40, and the oxygen contained in atmospheric air supplied through air holes 63 of air supply unit 60.

During the above process, since air supply unit 60 is exposed to atmospheric air, the vaporized moisture generated in second electrode layer 52 is condensed in air holes 63 of air supply unit 60 as it contacts relatively low temperature atmospheric air. Therefore, the condensed water coheres with air holes 63 to block air holes 63 and thus atmospheric air cannot be effectively supplied to second electrode layer 52 through air holes 63. In order to solve this problem, the present exemplary embodiment includes absorbing member 70 formed between air supply unit 60 and MEA 50. Absorbing member 70 functions as a filter for absorbing the condensed water generated from second electrode layer 52.

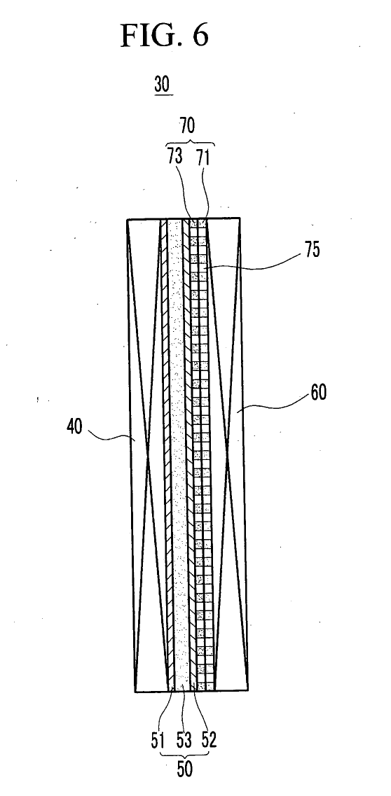

FIG. 6 is a sectional view of electricity generation unit 30 of fuel cell 100 to show arrangement of fuel supply unit 40, MEA 50, absorbing member 70, and air supply unit 60. As shown in FIGS. 1 and 6, absorbing member 70 is provided in the form of a sheet interposed between the air supply unit 60 and the MEA 50. Absorbing member 70 includes porous layer 71 formed of a porous medium material and moisture absorption layer 73 integrally formed on at least one surface of porous layer 71. Porous layer 71 can be formed of porous carbon paper or porous carbon cloth. That is, porous layer 71 functions as a storage unit for storing absorbed moisture. In addition, moisture absorption layer 73 formed on at least one surface of porous layer 71 can be formed of zeolite or phosphoric oxide (P₂O₅).

Absorbing member 70 is interposed between air supply unit 60 and MEA 50. That is, absorbing member 70 is disposed in close contact with second electrode layer 52 of MEA 50. Absorbing member 70 is provided with a plurality of holes 75 communicating with air holes 63 of air supply unit 60 in order to effectively supply atmospheric air to second electrode layer 52 of MEA 50 through air holes 63 of air supply unit 60. In other words, positions of holes 75 of absorbing member 70 is aligned to the positions of air holes 63 of air supply unit 60.

The following will describe the operation of the above described fuel cell constructed as an exemplary embodiment of the present invention. Two electricity generation unit 30 are symmetrically disposed on both opposite surfaces of medium member 20, and therefore, operation of one electricity generation unit 30 will be described. Fuel cell 100 is connected to an electronic device through a cable, or is integrally mounted in the electronic device. Air supply units 60 of electricity generation units 30 are exposed to atmospheric air through a surface of fuel cell main body 11. In this state, a fuel supply device (not shown) supplies a fuel to first passage 23a of the medium member 20 through fuel injection portion 24. Then, the fuel passing through first passage 23a is discharged through outlets 22a of manifolds 22, and is distributed to first electrode layer 51 of MEA 50 through first passages 42 of fuel supply units 40. At this point, the fuel that cannot be directed to first electrode layers 51 of MEAs 50 is directed to second passage 23b of medium member 20 through inlets 22b of second passage 23b, and is then exhausted through fuel exhaust portion 25.

During the above process, since air supply unit 60 of the electricity generation unit 30 are exposed to atmospheric air, air is distributed to second electrode layer 52 of the MEA 50 through air holes 63 of air supply unit 60 by natural diffusion or convention thereof. Then, first electrode layer 51 of MEA 50 decompose hydrogen contained in a fuel into electrons and hydrogen ions (protons) through an oxidation reaction between the fuel and atmospheric air. The hydrogen ions (protons) move to second electrode layers 52 through electrolyte layers 53 of MEAs 50. The electrons cannot pass through electrolyte layers 53, but are directed to air supply units 60 of electricity generation units 30 through an electrical connector that connects protrusion 66 of air supply unit 60 to protrusion 46 of fuel supply unit 40.

By the movement of the electrons, fuel cell 100 generates current, and thus fuel supply unit 40 and air supply unit 60, which include current collection plates 44 and 64, respectively, output electric energy having a predetermined potential difference to an electronic device.

Meanwhile, second electrode layer 52 generates heat and vaporized moisture through a reduction reaction between the hydrogen ions supplied through the electrolyte layers 53, the electrons supplied through fuel supply unit 40 and air supply unit 60, and atmospheric air supplied through air holes 63 of air supply units 60.

The moisture generated from second electrode layer 52 of MEA 50 is absorbed by absorbing member 70 interposed between MEA 50 and air supply unit 60. Since moisture absorption layer 73 of absorbing member 70 closely contacts second electrode layer 52 of MEA 50, the moisture is absorbed by moisture absorption layer 73 and is then stored in porous layer 71. The moisture stored in porous layer 71 is vaporized by the heat generated in second electrode layer 52 of MEA 50.

Since the moisture generated from second electrode layer 52 of MEA 50 is effectively absorbed by absorbing member 70, the blocking of the air holes 63 of air supply units 60 by the moisture can be prevented.

In the embodiment described above, a pair of electricity generation units 30 is provided on both opposite surfaces of medium member 20, and air supply unit 60 of electricity generation unit 30 is exposed to atmospheric air through fuel cell main body 11. However, the present invention is not limited to this structure. The fuel cell can be formed in a mono-polarity type, in which electricity generation unit 30 is a planar fuel cell main body and atmospheric air is supplied to one surface of the planar fuel cell main body.

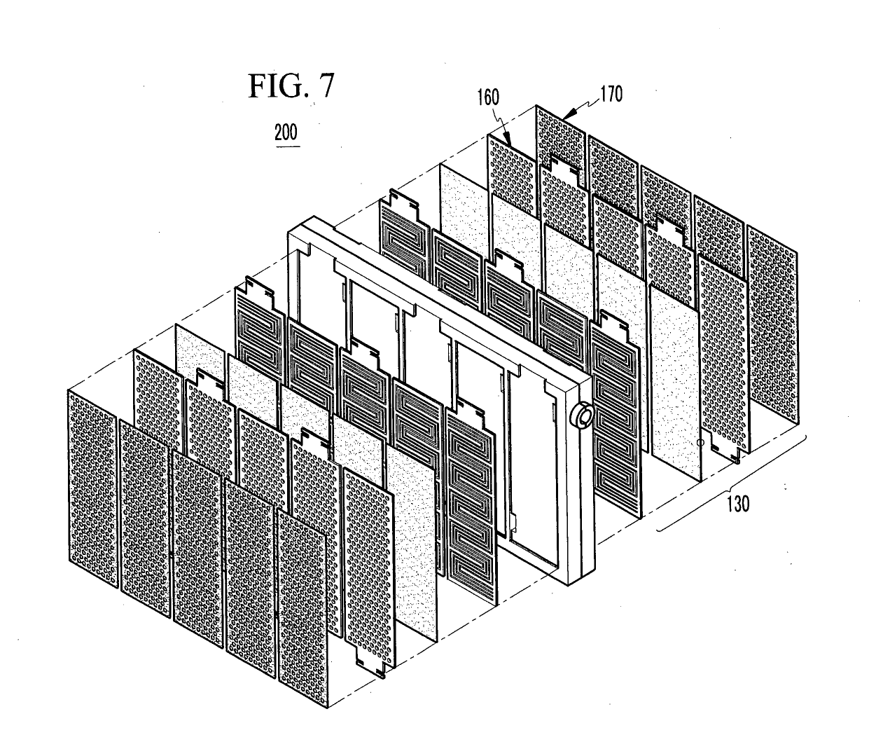

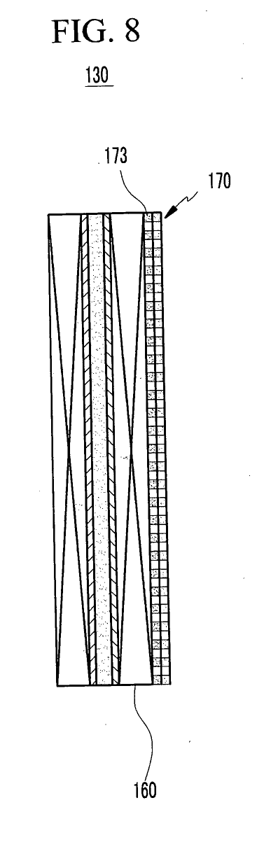

FIG. 7 is an exploded perspective view of a fuel cell constructed as another exemplary embodiment of the present invention, and FIG. 8 is an electricity generation unit of the fuel cell constructed as another exemplary embodiment of the present invention.

Referring to FIGS. 7 and 8, the structure of the fuel cell of this exemplary embodiment is basically identical to that of the fuel cell described referring to FIG. 1, except that relative positions of absorbing member 170 and air supply unit 160 are switched. Electricity generation unit 130 of this embodiment is designed to include absorbing member 170 disposed in close contact with an exposed (or outer) surface of air supply unit 160. That is, absorbing member 170 of the present exemplary embodiment has a structure identical to that of fuel cell 100 described referring to FIG. 1, but a moisture absorption layer 173 contacts the exposed (or outer) surface of air supply unit 160. Herein, the exposed or outer surface of an air supply unit is defined as a surface of the air supply unit that is exposed to atmospheric air or faces toward atmospheric air.

Since other structures and operation of the fuel cell of this embodiment are identical to those of the embodiment referring to FIG. 1, a detailed description thereof will be omitted herein.

Meanwhile, when absorbing member 170 is arranged on an exposed surface of air supply unit 160, absorbing member 170 is able to absorb moisture generated outside the fuel cell main body (inside outer case of the fuel cell) as well as the moisture generated from the electricity generation unit. As a final product, an outer case is provided to enclose the fuel cell main body. Therefore, when the fuel cell operates, moisture may be generated inside the outer case due to a temperature difference between an interior and exterior of the outer case. The temperature of the interior of the outer case is relatively high due to the heat generated from the fuel cell main body.

When moisture remains in the outer case, a device coupled to the fuel cell can be adversely affected. Therefore, when the absorbing member is provided on the exposed surface of the air supply unit, the absorbing member absorbs moisture generated inside the outer case. Therefore, the damage of the device coupled to the fuel cell can be prevented.

In this case, the absorbing member may be formed of a material including melamine. The absorbing member may be substantially provided in the form of a sheet with an opening corresponding to the opening (for the airflow) of the outer case. Furthermore, the absorbing member can be formed in a multi-layer structure. At this point, a layer facing the outer case may be colored with a color corresponding to a color of the outer case.

In the embodiments described above, the absorbing member of the exemplary embodiment of the present invention is applied to a passive type fuel cell where the atmospheric air is directly supplied to the fuel cell main body. However, the present invention is not limited to this type of fuel cell. For example, the absorbing member may be applied to all of other types of fuel cells as well as the above described fuel cell.

According to the present invention, since the electricity generation unit has an absorbing member that can absorb moisture generated by the electrochemical reaction between the fuel and the oxygen, the blocking of the air holes of the air supply unit by the moisture can be prevented. Therefore, atmospheric air can be effectively supplied through the air holes of the air supply units and thus the performance efficiency and reliability of the fuel cell can be further improved. In addition, since the air supply units of the electricity generation unit are exposed to atmospheric air through the both opposite surface of the fuel cell main body, the air can be effectively supplied to the air supply units regardless of the user environment. Furthermore, the heat generated from the air supply units can be effectively dissipated. As a result, the output of the electric energy can be maximized and the hazard that may be caused by the increase of the temperature of the fuel cell main body can be avoided, thereby further improving the performance and reliability of the fuel cell.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A fuel cell comprising:
a fuel supply unit;
an air supply unit;
a membrane electrode assembly disposed between the fuel supply unit and the air supply unit; the membrane electrode assembly including a first electrode layer, a second electrode layer, and an electrolyte layer disposed between the first electrode layer and the second electrode layer; the fuel supply unit contacting the first electrode layer and supplying fuel to the membrane electrode assembly; the air supply unit supplying air to the membrane electrode assembly; and
an absorbing member coupled to the air supply unit for absorbing moisture.

2. The fuel cell of claim 1, comprised of the absorbing member disposed between the air supply unit and the membrane electrode assembly.

3. The fuel cell of claim 1, wherein a surface of the air supply unit is exposed to atmospheric air.

4. The fuel cell of claim 3, comprised of the absorbing member coupled on the surface of the air supply unit exposed to atmospheric air.

5. The fuel cell of claim 1, comprised of the absorbing member formed of a porous medium material.

6. The fuel cell of claim 1, comprised of the air supply unit including a plurality of air holes through which atmospheric air is supplied to the membrane electrode assembly.

7. The fuel cell of claim 6, comprised of the absorbing member including a plurality of holes, the holes of the absorbing member being aligned to the air holes.

8. A fuel cell comprising:
a medium member including at least one unit region and a manifold formed on the unit region, fuel flowing through the manifold;
an air supply unit including a second passage through which air flows;
a fuel supply unit disposed between the medium member and the air supply unit; the fuel supply unit including a first passage through which fuel flows; the fuel supply unit mounted on the unit region; fuel flowing from or to the fuel supply unit through the manifold of the unit region;
a membrane electrode assembly disposed between the fuel supply unit and the air supply unit; the membrane electrode assembly contacting the fuel supply unit; fuel being supplied from the fuel supply unit and air being supplied from the air supply unit; oxidation and reduction reaction of fuel and air being performed in the membrane electrode assembly; and
an absorbing member coupled to the air supply unit for absorbing moisture.

9. The fuel cell of claim 8, comprised of the absorbing member disposed between the air supply unit and the membrane electrode assembly.

10. The fuel cell of claim 8, wherein a surface of the air supply unit is exposed to atmospheric air.

11. The fuel cell of claim 10, comprised of the absorbing member coupled to the surface of the air supply unit exposed to atmospheric air.

12. The fuel cell of claim 8, wherein the absorbing member includes:
a porous layer formed of a porous medium material for storing moisture; and
a moisture absorption layer formed on a surface of the porous layer for absorbing moisture.

13. The fuel cell of claim 12, wherein the moisture absorption layer is made of zeolite or phosphoric oxide (P₂O₅).

14. The fuel cell of claim 12, wherein the absorbing member is disposed between the air supply unit and the membrane electrode assembly, and the moisture absorption layer contacts the moisture absorption layer.

15. The fuel cell of claim 10, wherein the absorbing member includes:
a porous layer formed of a porous medium material for storing moisture; and
a moisture absorption layer formed on a surface of the porous layer for absorbing moisture, the moisture absorption layer contacting the surface of the air supply unit exposed to atmospheric air.

16. The fuel cell of claim 8, comprised of the medium member including a fuel passage connected to the manifold.

17. The fuel cell of claim 8, wherein the medium member provides insulation and has a plate shape, the medium member including at least two unit regions and the unit regions being spaced apart from each other.

18. The fuel cell of claim 17, wherein the unit regions are symmetrically formed on both surfaces of the medium member, a coupling groove being formed between the unit regions, the fuel supply unit being mounted on the unit region through the coupling groove.

19. The fuel cell of claim 8, comprised of the first passage formed in a meander shape.

20. The fuel cell of claim 8, comprised of the second passage including a plurality of air holes.

21. The fuel cell of claim 20, comprised of the absorbing member including a plurality of holes, the holes of the absorbing member being aligned to the air holes.

22. The fuel cell of claim 8, wherein the air supply unit includes a first current collection plate and the fuel supply unit includes a second current collection plate, polarity of the first current collection plate and polarity of the second current collection plate being different.
